(19) United States
(12) Patent Application Publication
(10) Pub. No.: US 2026/0010713 A1
(43) Pub. Date: Jan. 8, 2026

(54) METHOD AND SYSTEM FOR A GENERATIVE MACHINE LEARNING FRAMEWORK GENERATING PREDICTIVE RESULTS

(71) Applicant: JPMorgan Chase Bank, N.A., New York, NY (US)

(72) Inventor: Yingzhao ZHOU, Hook (GB)

(73) Assignee: JPMorgan Chase Bank, N.A., New York, NY (US)

(21) Appl. No.: 18/764,831

(22) Filed: Jul. 5, 2024

(51) Int. Cl. G06F 40/205

(52) U.S. Cl. CPC G06F 40/205

(57) ABSTRACT

A method and system for a generative machine learning (ML) framework generating predictive results regarding financial transactions. The method includes generating the generative ML framework by connecting: a base layer; a data processing layer; at least one large language model (LLM) layer; a ML processing layer; and an applications layer. The method further includes executing the generative ML framework by: storing and receiving a first data; performing data processing procedures on the first data resulting in a standardized data, wherein the standardized data includes at least one specific case involving the financial transactions. The operations further include parsing the standardized data to generate analytical results with natural language descriptions; inputting, into the ML processing layer, the analytical results; performing predictive modeling of the analytical results to generate the predictive results; transmitting the predictive results; and generating at least one application model based on the predictive results.

### BACKGROUND

### 1. Field of the Disclosure

This technology generally relates to methods and systems for a generative machine learning (ML) framework generating predictive results regarding financial transactions.

### 2. Background Information

In the realm of software development or testing, particularly in the domain of financial transactions, ensuring the robustness and reliability of payment systems is of paramount importance. Conventional testing methodologies often fall short in comprehensively covering the diverse scenarios and edge cases that real-world payment systems encounter and requires large human involvement to manually create required test data and test cases. Therefore, it is imperative to determine such diverse scenarios and edge cases that real-world payment systems encounter and doing so presently requires large human involvement to manually create required test data and test cases.

Accordingly, there is a need for techniques for a machine learning (ML) framework with at least one ML model operating in a production status, e.g., in a software development environment, to analyze a large amount of data and generate predictive analytics related to the large amount of data regarding the financial transactions and test cases. That is, there is a need for a generative machine learning (ML) framework generating predictive results regarding financial transactions.

### SUMMARY

The present disclosure, through one or more of its various aspects, embodiments, and/or specific features or sub-components, provides, inter alia, various systems, servers, devices, methods, media, programs, and platforms for a generative machine learning (ML) framework generating predictive results regarding financial transactions.

According to an aspect of the present disclosure, a method for a generative machine learning (ML) framework generating predictive results regarding financial transactions is provided. The method may be implemented by at least one processor. The method may include: generating the generative ML framework by connecting a plurality of layers, wherein the plurality of layers comprises: a base layer positioned as a bottom layer of the generative ML framework; a data processing layer; at least one large language model (LLM) layer; a ML processing layer; and an applications layer positioned as a top layer in the generative ML framework.

The method further includes executing the generative ML framework by performing operations including: storing, at the base layer, a first data from a plurality of databases; receiving, by the data processing layer, the first data at the base layer; performing, by the data processing layer, data processing procedures on the first data that results in a standardized data for input into the at least one LLM layer, wherein the standardized data comprises an association with at least one specific case that comprises the financial transactions; parsing, by the at least one LLM layer, the standardized data to generate analytical results with natural language descriptions of the analytical results; inputting, by the at least one LLM layer into the ML processing layer, the analytical results; performing, by the ML processing layer, predictive modeling of the analytical results to generate the predictive results; transmitting, by the ML processing layer to the applications layer, the predictive results; and generating, by the applications layer, at least one application model based on the predictive results.

The generating the generative ML framework by connecting the plurality of layers includes: connecting the base layer positioned as the bottom layer of the generative ML framework with the data processing layer; connecting the data processing layer with the at least one large LLM layer; connecting the at least one LLM layer with the ML processing layer; and connecting the ML processing layer with the applications layer positioned as the top layer in the generative ML framework.

The received first data includes at least one from among business data, commercial data, financial records data, transaction logs data, and current test case data; and the plurality of databases includes at least one from among historical databases, business databases, financial databases, and software testing databases.

The performing the data processing procedures includes: extracting the first data from the plurality of databases at the base layer; transforming the first data into a predetermined standardized format resulting in the standardized data; and loading the standardized data for the input into the at least one LLM layer.

The transforming the first data into the predetermined standardized format includes at least one from among: normalization of the first data; converting unstructured data into structured data; validating the first data; cleansing the first data to remove at least one from among errors, duplications, and corruptions of the first data; and tokenization of the first data.

The performing the predictive modeling includes performing at least one from among classification, clustering, regression, and anomaly detection of the analytical results; and wherein the method further comprises performing, by the ML processing layer, a generation of at least one synthetic test case data associated with the at least one specific case based on the predictive modeling.

The generating of the at least one application model comprises: implementing automated user acceptance testing (UAT) processes for at least one test case data associated with the at least one specific case; creating a fully integrated user testing framework with a corresponding application programming interface associated with the implemented UAT processes; and constructing a feedback loop incorporated with the fully integrated user testing framework to obtain user feedback for updating the generative ML framework via the applications layer.

The parsing of the standardized data includes: performing natural language processing (NLP) comprising sentiment analysis, entity recognition, and summarization of the standardized data; and performing risk assessment associated with the standardized data.

The method further includes performing, by the at least one LLM layer, of at least one from among: transfer learning between different LLM models; fine tuning of hyperparameters; multi-task learning; multi-modal learning; and model interpretations and explanations via at least one from among attention mechanisms, saliency maps, and feature analyses.

According to another embodiment, a computing apparatus for implementing a generative machine learning (ML) framework generating predictive results regarding financial transactions is provided. The computing apparatus includes: a processor; a memory; a display; and a communication interface coupled to each of the processor, the memory, and the display.

The processor is configured to: generate the generative ML framework by connecting a plurality of layers, wherein the plurality of layers comprises: a base layer positioned as a bottom layer of the generative ML framework; a data processing layer; at least one large language model (LLM) layer; a ML processing layer; and an applications layer positioned as a top layer in the generative ML framework.

The processor is further configured to: execute the generative ML framework by performing operations including: store, at the base layer, a first data from a plurality of databases; receive, by the data processing layer, the first data at the base layer; perform, by the data processing layer, data processing procedures on the first data that results in a standardized data for input into the at least one LLM layer, wherein the standardized data comprises an association with at least one specific case that comprises the financial transactions; parse, by the at least one LLM layer, the standardized data to generate analytical results with natural language descriptions of the analytical results; input, by the at least one LLM layer into the ML processing layer, the analytical results; perform, by the ML processing layer, predictive modeling of the analytical results to generate the predictive results; transmit, by the ML processing layer to the applications layer, the predictive results; and generate, by the applications layer, at least one application models based on the predictive results.

The generate the generative ML framework by connecting the plurality of layers includes: connecting the base layer positioned as the bottom layer of the generative ML framework with the data processing layer; connecting the data processing layer with the at least one large LLM layer; connecting the at least one LLM layer with the ML processing layer; and connecting the ML processing layer with the applications layer positioned as the top layer in the generative ML framework.

The perform the data processing procedures includes: extracting the first data from the plurality of databases at the base layer; transforming the first data into a predetermined standardized format resulting in the standardized data; and loading the standardized data for the input into the at least one LLM layer.

The transforming the first data into the predetermined standardized format includes at least one from among: normalization of the first data; converting unstructured data into structured data; validating the first data; cleansing the first data to remove at least one from among errors, duplications, and corruptions of the first data; and tokenization of the first data.

The perform the predictive modeling includes performing at least one from among classification, clustering, regression, and anomaly detection of the analytical results; and wherein the processor is further configured to perform, by the ML processing layer, a generation of at least one synthetic test case data associated with the at least one specific case based on the predictive modeling.

The parse of the standardized data includes: performing natural language processing (NLP) comprising sentiment analysis, entity recognition, and summarization of the standardized data; and performing risk assessment associated with the standardized data; and wherein the processor is further configured to perform, by the at least one LLM layer, procedures including at least one from among: transfer learning between different LLM models; fine tuning of hyperparameters; multi-task learning; multi-modal learning; and model interpretations and explanations via at least one from among attention mechanisms, saliency maps, and feature analyses.

According to yet another embodiment, a non-transitory computer readable storage medium storing instructions for a generative machine learning (ML) framework generating predictive results regarding financial transactions is provided. The non-transitory computer readable storage medium comprising executable code which, when executed by a processor, causes the processor to: generate the generative ML framework by connecting a plurality of layers, wherein the plurality of layers comprises: a base layer positioned as a bottom layer of the generative ML framework; a data processing layer; at least one large language model (LLM) layer; a ML processing layer; and an applications layer positioned as a top layer in the generative ML framework.

The processor is further configured to execute the generative ML framework by performing operations including: store, at the base layer, a first data from a plurality of databases; receive, by the data processing layer, the first data at the base layer; perform, by the data processing layer, data processing procedures on the first data that results in a standardized data for input into the at least one LLM layer, wherein the standardized data comprises an association with at least one specific case that comprises the financial transactions; parse, by the at least one LLM layer, the standardized data to generate analytical results with natural language descriptions of the analytical results; input, by the at least one LLM layer into the ML processing layer, the analytical results; perform, by the ML processing layer, predictive modeling of the analytical results to generate the predictive results; transmit, by the ML processing layer to the applications layer, the predictive results; and generate, by the applications layer, at least one application models based on the predictive results.

The generate the generative ML framework by connecting the plurality of layers comprises: connecting the base layer positioned as the bottom layer of the generative ML framework with the data processing layer; connecting the data processing layer with the at least one large LLM layer; connecting the at least one LLM layer with the ML processing layer; and connecting the ML processing layer with the applications layer positioned as the top layer in the generative ML framework.

The perform the data processing procedures comprises: extracting the first data from the plurality of databases at the base layer; transforming the first data into a predetermined standardized format resulting in the standardized data; and loading the standardized data for the input into the at least one LLM layer; and wherein the transforming the first data into the predetermined standardized format includes at least one from among: normalization of the first data; converting unstructured data into structured data; validating the first data; cleansing the first data to remove at least one from among errors, duplications, and corruptions of the first data; and tokenization of the first data.

The perform the predictive modeling includes performing at least one from among classification, clustering, regression, and anomaly detection of the analytical results; and wherein the non-transitory computer readable storage medium includes further executable code which causes the processor to perform, by the ML processing layer, a generation of at least one synthetic test case data associated with the at least one specific case based on the predictive modeling.

The parsing of the standardized data includes: performing natural language processing (NLP) comprising sentiment analysis, entity recognition, and summarization of the standardized data; and performing risk assessment associated with the standardized data; and wherein the non-transitory computer readable storage medium includes further executable code which causes the processor to further perform, by the at least one LLM layer, procedures comprising at least one from among: transfer learning between different LLM models; fine tuning of hyperparameters; multi-task learning; multi-modal learning; and model interpretations and explanations via at least one from among attention mechanisms, saliency maps, and feature analyses.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for a generative machine learning (ML) framework generating predictive results regarding financial transactions.

FIG. 4 illustrates a flowchart of a process diagram according to an embodiment for a generative machine learning (ML) framework generating predictive results regarding financial transactions.

FIG. 5 illustrates an example generative machine learning (ML) framework for generating predictive results regarding financial transactions.

### DETAILED DESCRIPTION

In the realm of software development or testing, particularly in the domain of financial transactions, ensuring the robustness and reliability of payment systems is of paramount importance. Conventional testing methodologies often fall short in comprehensively covering the diverse scenarios and edge cases that real-world payment systems encounter and requires large human involvement to manually create required test data and test cases. Therefore, it is imperative to determine such diverse scenarios and edge cases that real-world payment systems encounter and doing so presently requires large human involvement to manually create required test data and test cases.

To address this issue, the present application leverages large machine learning (ML) models, such as Large Language Models (LLMs) for generating of test data and test cases regarding financial transactions such as automated payment testing. The generative ML framework harnesses the power of LLMs to generate diverse and realistic test data and cases for payment use cases using millions of data. By training the LLMs on, e.g., millions of payment-related data, including transaction logs, system specifications, past test data and scenarios and production incidents, the generative ML framework enables the generation of relative contextual and relevant test data and scenarios. These generated test cases cover a wider range of scenarios that may be used for financial subject matter such as, but not limited to, current key payment migration program end-to-end testing.

The present application addresses these limitations in the status quo by enabling the generative ML framework for generating predictive results regarding financial transactions as described below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

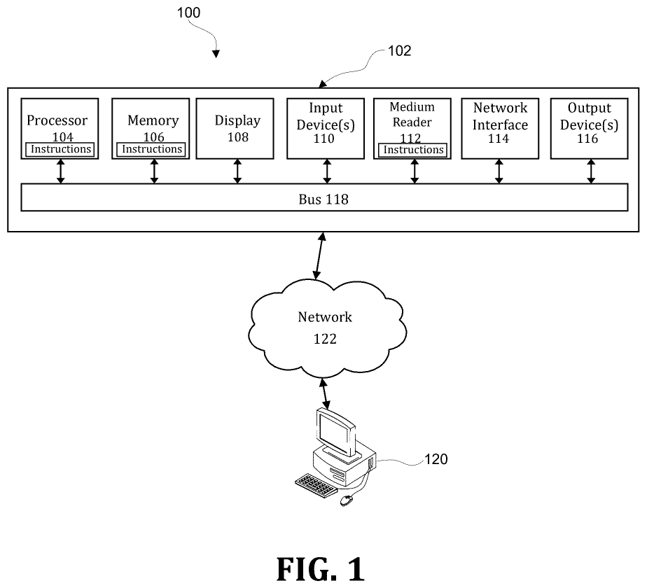

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide optimized methods and systems for a generative machine learning (ML) framework generating predictive results regarding financial transactions.

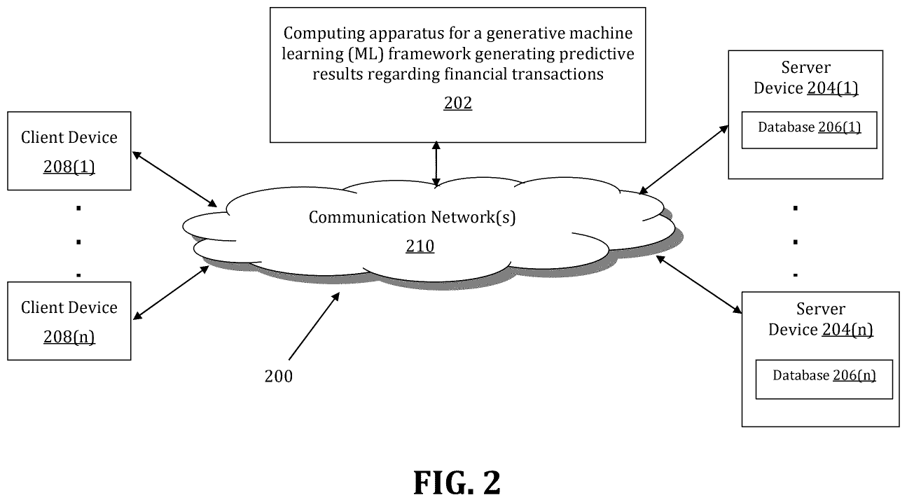

Referring to FIG. 2, a network diagram of a network environment 200 for implementing a method for a generative machine learning (ML) framework generating predictive results regarding financial transactions may be illustrated. In an embodiment, the method may be executable on any networked computer platform, such as, for example, a personal computer (PC).

The method for a generative ML framework generating predictive results regarding financial transactions may be implemented by a computing apparatus 202 that implements a generative ML framework generating predictive results regarding financial transactions. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for a generative ML framework generating predictive results regarding financial transactions.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to PI data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

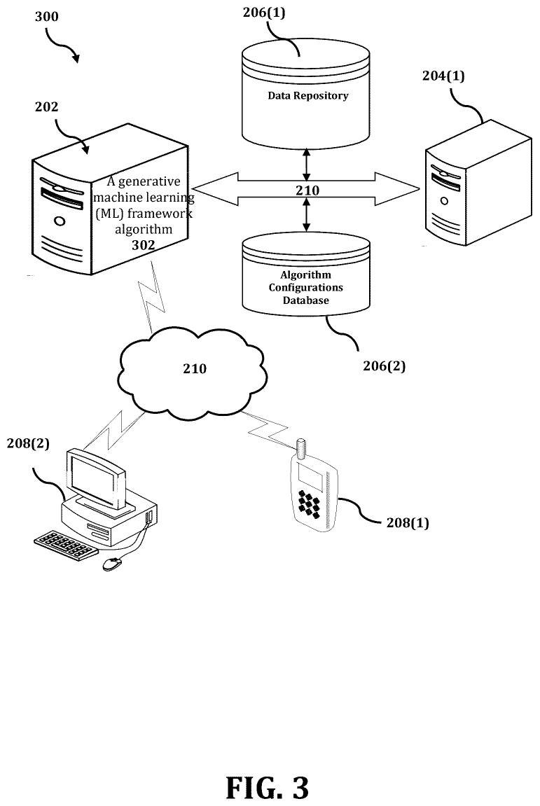

The computing apparatus 202 may be described and illustrated in FIG. 3 as including a generative machine learning (ML) framework algorithm 302, although it may include other rules, algorithms, policies, modules, databases, or applications, for example. As will be described below, the generative ML framework algorithm 302 may be configured to implement a method for generative ML framework.

FIG. 3 illustrates a diagram of a system environment 300 for implementing a method for a generative machine learning (ML) framework generating predictive results regarding financial transactions by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository 206(1) and an algorithm configurations database 206(2). The generative ML framework algorithm 302 may be configured to access these databases for implementing the generative ML framework generating predictive results regarding financial transactions.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

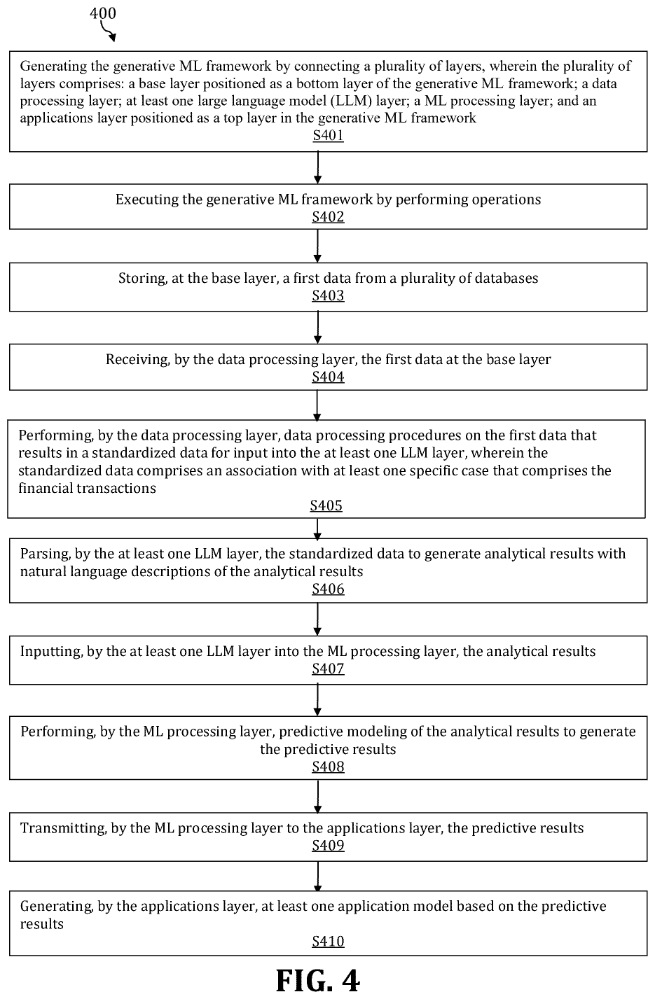

Upon being started, the generative ML framework algorithm 302 executes a process implementing a method for the generative ML framework generating predictive results regarding financial transactions. A process for the generative ML framework generating predictive results regarding financial transactions may be generally indicated at flowchart 400 in FIG. 4.

FIG. 4 illustrates a flowchart of a process diagram 400 of a process for implementing a method for a generative machine learning (ML) framework generating predictive results regarding financial transactions according to an embodiment.

At step S401 of the flowchart process 400, the computing apparatus 202 generates the generative ML framework by connecting a plurality of layers, wherein the plurality of layers comprises: a base layer positioned as a bottom layer of the generative ML framework; a data processing layer; at least one large language model (LLM) layer; a ML processing layer; and an applications layer positioned as a top layer in the generative ML framework. The computing apparatus may utilize the generative ML framework algorithm 302 to generate the generative ML framework.

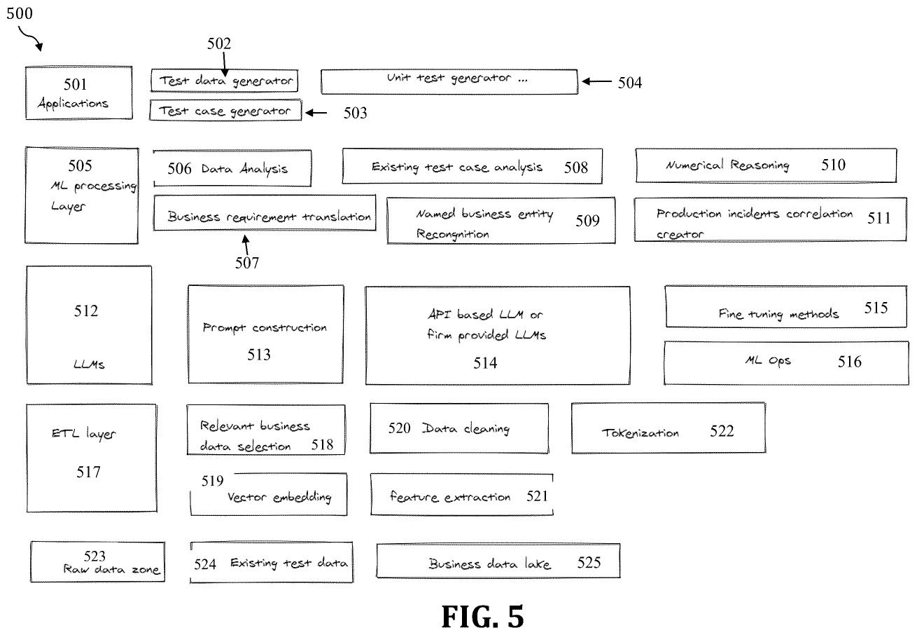

In an embodiment, the generating the generative ML framework by connecting the plurality of layers comprises: connecting the base layer positioned as the bottom layer of the generative ML framework with the data processing layer; connecting the data processing layer with the at least one large LLM layer; connecting the at least one LLM layer with the ML processing layer; and connecting the ML processing layer with the applications layer positioned as the top layer in the generative ML framework. An example of the generative ML framework is shown in FIG. 5.

At step S402, the generative ML framework may be executed by performing operations comprising the steps of S403-S410. In an example, the generative ML framework algorithm 302 may execute the generative ML framework, wherein the computing apparatus 202 implements the generative ML framework algorithm 302.

At step S403, the generative ML framework may store, at the base layer of the generative ML framework, a first data from a plurality of databases. In an example, the plurality of databases comprises at least one from among historical databases, business databases, financial databases, and software testing databases.

At step S404, the generative ML framework may receive, by the data processing layer, the first data at the base layer. In an example, the received first data comprises at least one from among business data, commercial data, financial records data, transaction logs data, and current test case data.

At step S405, the generative ML framework performs, by the data processing layer, data processing procedures on the first data that results in a standardized data for input into the at least one LLM layer, wherein the standardized data comprises an association with at least one specific case that comprises the financial transactions.

Continuing with the step S405, the performing the data processing procedures comprises: extracting the first data from the plurality of databases at the base layer; transforming the first data into a predetermined standardized format resulting in the standardized data; and loading the standardized data for the input into the at least one LLM layer. Furthermore, the transforming the first data into the predetermined standardized format comprises at least one from among: normalization of the first data; converting unstructured data into structured data; validating the first data; cleansing the first data to remove at least one from among errors, duplications, and corruptions of the first data; and tokenization of the first data.

At step S406, the generative ML framework may parse, by the at least one LLM layer, the standardized data to generate analytical results with natural language descriptions of the analytical results. The parsing of the standardized data comprises: performing natural language processing (NLP) comprising sentiment analysis, entity recognition, and summarization of the standardized data; and performing risk assessment associated with the standardized data.

At step S407, the analytical results may be inputted into the ML processing layer by the at least one LLM layer.

At step S408, the generative ML framework may perform, by the ML processing layer, predictive modeling of the analytical results to generate the predictive results. The performing the predictive modeling comprises performing at least one from among classification, clustering, regression, and anomaly detection techniques on the analytical results. The method further comprises performing, by the ML processing layer, a generation of at least one synthetic test case data associated with the at least one specific case based on the predictive modeling.

At step S409, the predictive result may be transmitted by the ML processing layer to the applications layer.

At step S410, the generative ML framework may generate, by the applications layer, at least one application model based on the predictive results. The generating of the at least one application model comprises: implementing automated user acceptance testing (UAT) processes for at least one test case data associated with the at least one specific case; creating a fully integrated user testing framework with a corresponding application programming interface associated with the implemented UAT processes; and constructing a feedback loop incorporated with the fully integrated user testing framework to obtain user feedback for updating the generative ML framework via the applications layer.

In an embodiment, the generative ML framework may further comprise performing, by the at least one LLM layer, of at least one from among: transfer learning between different LLM models; fine tuning of hyperparameters; multi-task learning; multi-modal learning; and model interpretations and explanations via at least one from among attention mechanisms, saliency maps, and feature analyses.

In an example, the fine tuning of hyperparameters may include fine tuning of hyperparameters such as, but are not limited to, learning rate, training epochs, layers and nodes of the ML model, layers of the ML framework, activation function, etc. The fine tuning may involve using techniques such as, but is not limited to, grid search, Bayesian optimization, random search, bandit, etc. The grid search involves testing and evaluating every possible combination of hyperparameters within a predefined search space that enables an optimum selection of the hyperparameter combination for operation. The random search involves random selection of hyperparameter combinations and evaluating this random selection to determine the optimum selection of hyperparameter combination for operation. The Bayesian optimization involves using a probabilistic model of an objective function (e.g., the performance of the ML model and/or performance of the generative ML framework). The bandit-based technique may include hyperband, which is an early-stopping adaptive resource allocation technique that uses resource allocation of iterations of a metric (e.g., data, number of features, etc.) to allocate these resources to a randomly sampled configuration.

In yet another example, the attention mechanisms may include, but are not limited to, self-attention, multi-head attention, additive attention, etc. In yet another example, the transfer learning between different LLM models may include using a pre-trained LLM model. Additionally, in yet another example, the transfer learning between different LLM models may include using techniques such as, but are not limited to, inductive transfer learning with labeled source data and labeled output target data, transductive transfer learning with labeled source data and unlabeled output target data, and/or supervised learning based on at least one of the inductive learning and/or transductive learning. The transfer learning between different LLM models may also include using techniques such as, but are not limited to, self-learning based on unlabeled source data and labeled output target data, unsupervised learning based on unlabeled and unlabeled output target data, and/or self-supervised learning based on at least one of the self-learning and/or the unsupervised learning.

The generative ML framework and its various respective layer and their operations are further described in FIG. 5.

FIG. 5 illustrates an example generative machine learning (ML) framework 500 for generating predictive results regarding financial transactions according to an embodiment. In FIG. 5, the applications layer 501 is positioned as a top layer in the generative ML framework, wherein the insights and outputs derived from the ML Processing Layer are utilized to build practical applications and solutions. These applications may include, but are not limited to, automated testing frameworks, recommendation systems, natural language processing tools, or other applications tailored to the specific needs of the business organization/user. As such, this enables the business organization or user or developer to use the generative ML framework by e.g., implementing a user interface for a corresponding use case, e.g. a chatbot-like interface for employees of the business to generate test cases for specific business problems. In an example, a test case generator 503 may generate these test cases. In yet another example, the test data generator 502 may generate test data for testing. In yet another example, a unit test generator 504 may be used for the testing.

The applications layer 501 may also provide User Acceptance Testing (UAT) Testing Automation to develop applications and tools to automate UAT processes, allowing employees/stakeholders of the business organization to define test scenarios, execute such tests, and provide feedback efficiently. This may include creating user-friendly interfaces for test case management, test execution, and result reporting, as well as integrating with existing project management and collaboration tools. The UAT process may be performed using the test data generator 502, test case generator 503, and/or the unit test generator 504.

In yet another example, the applications layer 501 may also provide a fully integrated client testing framework by building client-facing portals or application programming interfaces (APIs) for external clients/users to perform testing against the business organization's payment technology platform. Additionally, this fully integrated client testing framework may provide documentation, sample data, and sandbox environments to facilitate client testing and integration with client's systems, which may include implementing features for client onboarding, test case execution, and issue tracking to streamline the testing process and enhance collaboration with the client. The fully integrated client testing framework may be implemented using the test data generator 502, test case generator 503, and/or the unit test generator 504.

In yet another example, the applications layer 501 may also provide an integrated feedback loop by establishing feedback loops between production incidents, testing activities, and MLs models to continuously improve the quality of test cases and identify emerging issues. This may be achieved by, e.g., but not limited to, collecting feedback from UAT sessions, client testing sessions, and post-production incidents to refine test case generation algorithms, update test libraries, and prioritize future testing efforts. The integrated feedback loop may be performed using the test data generator 502, test case generator 503, and/or the unit test generator 504.

As such, the applications layer 501 may possess business/organizational awareness logic via e.g., the UAT, the fully integrated client testing framework, and/or the integrated feedback loop.

Furthermore, the applications layer 501 may also be scalable for other use cases besides financial transactions or be scalable for other business/organizational purposes. The scalability of the applications layer 501 is subsequently described below.

The applications layer 501 may be scalable by designing/generating modular and configurable applications that may be customized and extended to support various other cases such as, but not limited to, investment banking use cases without requiring significant redevelopment or reconfiguration. Additionally, the applications layer 501 may utilize microservices architecture, containerization, and API-based integration to facilitate interoperability and scalability of application components.

The applications layer 501 may also be scalable via role-based access control and security by implementing role-based access control (RBAC) and security policies to enforce fine-grained access permissions and data confidentiality across different user roles and use cases that integrates authentication, authorization, and encryption mechanisms into application workflows to protect sensitive information and mitigate security risks.

The applications layer 501 may also be scalable via performance monitoring and optimization by deploying monitoring and optimization tools to track application performance, resource utilization, and user/client interactions across multiple use cases and employs techniques such as, but not limited to, A/B testing, performance profiling, and/or anomaly detection to identify bottlenecks, inefficiencies, and/or opportunities for improvement in the application workflows and user/client experiences.

Continuing with FIG. 5, the machine learning (ML) processing layer 505 lies below the applications layer 501 and above the large language models (LLMs) layer 512. The ML processing layer 505 implements the ML algorithms and techniques against the output generated by the LLMs in the LLMs layer 512. The ML processing layer 505 may involve tasks such as classification, clustering, regression, or other forms of predictive modeling to derive insights, patterns, and/or recommendations from the processed data, e.g. analytical results derived from the first data. Or simply compare the results generated by the different LLMs to pick the optimal result that fits for a certain business/organizational case. For example, in a test case generation business/organizational case, the ML processing layer 505 would compare the different generated business/organizational case so that the optimal case may be used for testing. In another example, the ML processing layer 505 may compare data obtained from the LLMs layer 512 and try to combine that data with external tools, e.g., pairwise test scenario generation tool, to analyze the data obtained from the LLMs layer 512.

Additionally, the ML processing layer 505 may possess business/organizational awareness logic. For example, the ML processing layer 505 may provide test case generation by utilizing ML techniques, such as natural language processing (NLP), named business entity recognition 509, and/or anomaly detection, to perform data analysis 506 through analyzing production incidents and automatically generating test cases based on the observed patterns and issues. This may involve e.g., extracting relevant information from incident reports for existing test case analysis 508, identifying root causes, business/organizational requirement translation 507 that provide details regarding business/organization operations, and generating synthetic test scenarios that mimic real-world scenarios via a production incidents correlation creator 511.

The ML processing layer 505 may also possess business/organizational awareness logic via anomaly detection for testing by implementing anomaly detection algorithms to identify abnormal behavior or unexpected outcomes during testing. By monitoring system metrics, transaction flows, and user interactions, the generative ML framework may detect deviations from expected behavior and trigger alerts for further investigation or test case generation.

The ML processing layer 505 may also possess business/organizational awareness logic via regression testing optimization by implementing ML techniques including numerical reasoning 510 to optimize regression testing efforts by prioritizing test cases based on their likelihood of uncovering defects or regression issues. This may involve, e.g., analyzing historical test results, existing test case analysis 508, data analysis 506, code changes, named business entity recognition 509, business requirement translation 507, and system dependencies to identify high-risk areas and allocate testing resources efficiently.

Furthermore, the ML processing layer 505 may also be scalable for other use cases besides financial transactions or be scalable for other business/organizational purposes. The scalability of the ML processing layer 505 is subsequently described below.

The ML processing layer 505 may be scalable by feature engineering and selection by performing adaptive feature engineering and selection to identify relevant input features and representations for different various other cases such as, but not limited to, investment banking use cases and utilizes e.g., domain knowledge, feature importance analysis, and automatic feature selection algorithms to prioritize and refine input feature sets.

The ML processing layer 505 may also be scalable by algorithm selection and fine tuning of hyperparameters by evaluating and selecting machine learning algorithms and ML models for each use case based on e.g., performance, scalability, and interpretability requirements and conducts systematic hyperparameter tuning and ML model selection experiments to optimize predictive accuracy and generalization across diverse datasets and contexts.

The ML processing layer 505 may also be scalable by ensemble and meta-learning techniques by harnessing ensemble learning and meta-learning techniques to combine predictions from multiple ML models and algorithms within the ML processing layer 505 and develops ensemble strategies such as e.g., bagging, boosting, and stacking to improve robustness, diversity, and generalization of predictive ML models across different use cases, e.g., different investment bank use cases.

Continuing with FIG. 5, the Large Language Models (LLMs) layer 512 lies below the ML processing layer 505 and above the extract, transform, and load (ETL) layer 517. It is noted that although the term LLMs is used in the various descriptions and drawings, it is understood that this term denotes at least one LLM. That is, the layer can include one or more LLM model and have been denoted as LLMs layer, although it can also be denoted simply as an LLM layer.

The LLMs layer 512 represents the core of the generative ML framework. Here, the LLMs such as, but not limited to, generative transformer neural network models may be utilized to process and analyze the standardized data. The LLMs possess advanced natural language understanding capabilities for prompt construction 513, enabling them to comprehend and generate human-like text based on the input data. As an example, LLMs layer 512 may include at least one LLM or multiple LLMs for use in generating the analytical results. Additionally, the LLMs may be application programming interfaces (APIs) based LLMs and/or firm/business/organizational provided LLMs 514.

The LLMs layer 512 may possess business/organizational awareness logic via e.g., context aware language understanding such as financial language understanding. This may be implemented by fine tuning methods 515 of the LLMs, wherein an example of LLMs may be several generative transformer neural network models, for prompt construction 513 to understand and generate text related to the context of the business/organization such as, but not limited to, financial transactions, business requirements, regulatory requirements, and/or other domain-specific information.

The LLMs layer 512 may also possess business/organizational awareness logic via natural language processing (NLP) by utilizing the LLMs for tasks such as, but not limited to, sentiment analysis, named entity recognition, and/or summarization to extract insights from unstructured text data, such as, but not limited to, confluence page articles, research reports, and incidents and communications from management software that tracks incident reports and software issue for agile project management and software development.

The LLMs layer 512 may also possess business/organizational awareness logic via risk assessment by leveraging the LLMs to assess the risk associated with e.g., payment transactions, identify potential fraud or anomalies, and/or provide recommendations for risk mitigation strategies.

Furthermore, the LLMs layer 512 may also be scalable for other use cases besides financial transactions or be scalable for other business/organizational purposes. The scalability of the LLMs layer 512 is subsequently described below.

The LLMs layer 512 may be scalable via ML operations 516 such as, but not limited to, transfer learning and fine tuning methods 515 by implementing transfer learning techniques to leverage pre-trained LLMs for different investment bank use cases while fine tuning model parameters of the LLMs and hyperparameters of the LLMs based on domain-specific data and tasks, and to develop domain-specific language models and knowledge bases to enhance the LLMs performance and adaptability.

The LLMs layer 512 may also be scalable via model interpretability and explainability to enhance model interpretability and explainability by integrating techniques such as, but not limited to, attention mechanisms, saliency maps, and feature importance analysis into LLM architectures and provide tools and visualizations for stakeholders/users to understand and validate e.g., model predictions, recommendations, and insights across diverse use cases.

The LLMs layer 512 may also be scalable via multi-modal and multi-task learning by utilizing multi-modal and multi-task learning approaches to handle heterogeneous data inputs and diverse prediction tasks within the LLMs layer 512 and combines text, numerical, and categorical features across multiple modalities and tasks to capture richer semantics and context in model representations.

Continuing with FIG. 5, the extract, transform, and load (ETL) layer 517 lies below the LLMs layer and above the raw data zone layer 523. The ETL layer 517 may extract data, e.g., a first data, from diverse sources, and transforming the extracted data into a standardized format, resulting in a standardized data, and loading this standardized data into the data storage system. The ETL layer ensures data consistency, quality, and accessibility, by preparing the data (e.g., the first data) for further processing and analysis. In an example, schema extraction technology for feature extraction 521 may be used to convert raw data into structured data for the next layer, such as the LLMs layer 512 or another additional layers such as the ML processing layer 505 and/or the applications layers 501, to use. In yet another example, tokenization 522 of the data and data cleaning 520 may be performed as part of preparing the data. In yet another example, the ETL layer 517 may perform vector embedding 519 on the data.

The ETL layer 517 may possess business/organizational awareness logic via e.g., data integration by ensuring seamless integration of data from various sources within the business/organization (e.g., investment bank) such as, but not limited to, transaction systems, business/organizational case databases, market data feeds, and regulatory data sources by predefined business/organizational rules to extract relevant business/organizational data schema. For instance, the predefined business/organizational rules may include performing relevant business data selection 518.

The ETL layer 517 may also possess business/organizational awareness logic via e.g., data quality by implementing robust data quality controls to e.g., cleanse (i.e., data cleaning 520), validate, and standardize incoming data. Thus, ensuring accuracy and consistency of the data, e.g., the first data.

The ETL layer 517 may also possess business/organizational awareness logic via e.g., real-time processing of the data, e.g., the first data, by designing the ETL processes to handle real-time data streams, enabling timely processing of events such as, but not limited to, payment transactions and market events.

The ETL layer 517 may also possess business/organizational awareness logic via e.g., compliance and security by incorporating compliance checks and security measures to safeguard sensitive data such as, but not limited to, financial data. Thus, ensuring regulatory compliance with the law and regulatory agencies.

Furthermore, the ETL layer 517 may also be scalable for other use cases besides financial transactions or be scalable for other business/organizational purposes. The scalability of the ETL layer 517 is subsequently described below.

The ETL layer 517 may be scalable via adaptive data ingestion by implementing adaptable data ingestion pipelines that may ingest data from a wide range of sources and formats, including, but not limited to, structured databases, semi-structured files, and/or unstructured streams. ETL layer 517 may also implement techniques such as, but not limited to, dynamic schema detection, data profiling, and/or transformation rules to handle data variability and evolution over time.

The ETL layer 517 may also be scalable via orchestration and workflow management by implementing workflow orchestration tools and frameworks to automate and manage complex ETL processes across multiple use cases. The ETL layer 517 may also design reusable and parameterized workflows that may be customized and scaled based on specific requirements, dependencies, and/or scheduling constraints.

The ETL layer 517 may also be scalable via data lineage and auditing by establishing comprehensive data lineage and auditing mechanisms to track the movement and transformation of data through the ETL pipeline and captures metadata, lineage graphs, and provenance information to facilitate traceability, compliance, and troubleshooting across disparate data sources and transformations.

Continuing with FIG. 5, the raw data zone layer 523 lies below the ETL layer 517. The raw data zone layer 523 is positioned as a base layer at the bottom of the generative ML framework. The raw data zone layer 523 serves as a foundation wherein raw data from various sources within the business/organization may be stored. This data, e.g., first data, may include, but is not limited to, transaction logs, key business attributes information, financial records, existing/current test cases and data 524, business data lake 525, and/or any other relevant data pertaining to the business//organizational domain. The data can be structured or unstructured.

Furthermore, the raw data zone layer 523 may also be scalable for other use cases besides financial transactions or be scalable for other business/organizational purposes. The scalability of raw data zone layer 523 is subsequently described below.

The raw data zone layer 523 may be scalable via e.g., flexible data model by implementing a flexible data model structure that can accommodate diverse data types, structures, and schemas across different use cases, e.g., different investment banking use cases. Additionally, raw data zone layer 523 may allow for customization and configuration of data storage and indexing mechanisms to support specific data requirements and access patterns.

The raw data zone layer 523 may also be scalable via e.g., a data governance framework by implementing a robust data governance framework that enforces e.g., data quality standards, metadata management practices, and access controls across multiple use cases. Additionally, the data governance framework may also define clear data ownership, stewardship, and lineage for each data source to ensure transparency and accountability.

The raw data zone layer 523 may also be scalable via e.g., scalable data storage by choosing scalable and resilient data storage solutions, such as, but not limited to, distributed databases, data lakes (e.g., business data lake 525), or cloud storage services, that may handle the volume, velocity, and variety of data generated by diverse use cases. Consideration of factors for scalable data storage may include, but is not limited to, data partitioning, replication, and compression to optimize storage efficiency and performance.

As such, the generative ML framework may provide several key features regarding contextual understanding, scenario generation, adaptability, efficiency, scalability, and flexibility. For instance, the generative ML framework provides contextual understanding because it involves an LLM-based approach that enables the generative ML framework to understand the context of e.g., payment business domain, including business/organizational requirement, test user intent, transactional context, production incidents pattern and existing test data, and case constraints. Additionally, the generative ML framework provides scenario generation through fine tuning of payment-specific data by generating diverse and realistic test data and cases that cover both common and edge cases encountered in payment systems for one of a pilot use case, e.g., pilot test case. Furthermore, the generative ML framework provides adaptability by adapting based on evolving payment systems and regulatory requirements via re-training of the LLMs on updated datasets. Thus, ensuring continuous relevance and efficacy of the LLMs and generative ML framework. Moreover, the generative ML framework provides efficiency and scalability via automated test data and test case generation that may significantly reduce the manual effort involved in creating test cases, thereby improving efficiency and scalability in the testing process. Lastly, the generative ML framework may also be sufficiently flexible such that it may be reused in other business/organizational domains for other applications.

Utilization of the generative ML framework may provide benefits to the business/organization as well. For instance, the generative ML framework may provide improved test coverage. Conventional testing approaches often struggle to cover the wide array of scenarios and edge cases present in payment UAT end-to-end testing. By leveraging the generative ML framework, which may be trained on vast amounts of thousands and/or millions of business/organizational case domain specific data, the generative ML framework may generate diverse and realistic test scenarios, leading to improved test coverage. This helps to uncover the edge cases in testing.

Another benefit may be enhanced efficiency wherein operational efficiency of business/organization may be achieved via operation efficiency of the generative ML framework. For instance, automating the generation of test cases by the generative ML framework significantly reduces the manual effort required in creating and maintaining test scenarios, and significantly reduces the errors associated with such manual effort that impacts the business/organization's resources. Thus, the utilization of the generative ML framework leads to increased efficiency in the testing process, allowing businesses/organizations to test more comprehensively and expediently. As a result, time-to-market for new payment migration programs or updates are reduced, enabling the business/organization to deliver high-quality products and services more rapidly.

Another benefit may be cost savings because by automating test case generation, the efficiency in testing may be improved with the generative ML framework helping to reduce the overall cost associated with quality assurance for payment testing businesses/organizations. The reduction in manual effort translates into lower labor costs and resource requirements, making the testing process more cost-effective. Additionally, the generative ML framework's ability to detect defects and vulnerabilities early in the development lifecycle helps mitigate the risk of costly issues arising post-deployment.

Another benefit may be adaptability to change. Payment systems are subject to frequent updates, regulatory changes, and evolving user behaviors. The adaptability of the generative ML framework allows it to stay relevant and effective in detecting anomalies and compliance issues amidst these changes with minimal cost. By re-training the LLMs on updated datasets, the generative ML framework ensures that it can continue to generate relevant test scenarios that reflect the latest developments in payment technology and regulation with minimal cost and high efficiency and high relevancy.

Another benefit may be enhanced risk mitigation. Payment systems are critical infrastructures, and any disruptions or failures may have significant financial and reputational consequences. By thoroughly testing payment systems using diverse and realistic test scenarios, the generative ML framework helps to mitigate the risk of system failures, transaction errors, and security breaches.

The generative ML framework may be distinguishable from conventional techniques in the status quo by utilizing techniques such as, but not limited to, domain expertise integration, advanced artificial intelligence (AI) capabilities, customization and scalability, end-to-end solution offering, robust security and compliance, and client-centric approach. That is, the generative ML framework may be tailored based on utilizing the above techniques.

In an example, the generative ML framework may utilize domain expertise integration. The generative ML framework may leverage deep domain expertise to tailor it specifically to the needs and challenges of the business/organization, e.g., leveraging deep domain expertise in payment technology and banking operations for financial subject matter. The generative ML framework uses business/organizational specific data to understand the unique requirements, regulatory constraints, and industry standards that shape payment processing in that business/organization, and embed this knowledge into the design and implementation of the generative ML framework.

In another example, the generative ML framework may utilize advanced AI capabilities by incorporating cutting-edge AI technologies, including large language models (LLMs), reinforcement learning, and anomaly detection, to provide advanced capabilities for data processing, analysis, and decision-making. Additionally, the generative ML framework continuously integrates with emerging research and innovations in AI to stay ahead of the curve and offer state-of-the-art solutions to the business/organization's payment technology challenges. For instance, the present application describes an example using generative transformer neural network models for the LLMs, however, as more robust LLMs are newly developed, the generative ML framework can adapt and utilize those newly developed LLMs instead. Similarly, with the other aspects of the generative ML framework as described for the various layers and their operations, which can be adapted to utilize newly developed emerging techniques and technology.

In another example, the generative ML framework may be easily customizable and scalable, allowing for easy adaptation to evolving business/organizational requirements, regulatory changes, and technological advancements. The generative ML framework may provide modular components, configuration options, and application programming interfaces (APIs) that enable seamless integration with existing systems and workflows, while also accommodating future growth and expansion with newly developed emerging techniques and technology.

In another example, the generative ML framework may offer an end-to-end solution that covers integration and adoption capability to e.g., the entire payment lifecycle, from transaction initiation to settlement and reconciliation. The generative ML framework provide comprehensive tools and features for e.g., payment processing and risk management, compliance, as well as e.g., reporting and consolidating disparate systems and processes into a unified platform that enhances operational efficiency and agility. This may be proved by testing use cases during implementation.

In another example, the generative ML framework may enable robust security and compliance by prioritizing security and compliance measures to safeguard sensitive data (e.g., financial data), protect against fraud and cyber threats, and ensure regulatory adherence. The generative ML framework may implement industry best practices for encryption, access control, and data governance, and regularly audit and update security protocols to mitigate emerging risks and vulnerabilities.

In another example, the generative ML framework may adopt a client-centric approach to solution development and delivery by actively soliciting feedback and collaborating closely with internal stakeholders/users and external clients to understand their needs, preferences, and pain points. The generative ML framework may \Incorporate user/client/stakeholder's experience to design principles, usability testing, and agile methodologies to iteratively refine and enhance the generative ML framework based on real-world usage and feedback.

As such, the generative ML framework leverages a layered architecture comprising a plurality of layers to seamlessly integrate raw business data into actionable insights and applications, with each layer contributing to the overall processing and analysis pipeline. From data ingestion and transformation to advanced natural language processing (NLP) and ML techniques and models, the generative ML framework enables organizations to unlock the full potential of their data assets for business intelligence and decision-making.

Although the invention has been described with application to financial subject matter, e.g., financial transactions, investment banking, etc., it is understood that the generative ML framework as described in the present application is not solely restricted to just financial subject matter. The generative ML framework as described in the present application is applicable to any subject matter as so desired.

Additionally, it is noted that the description of the generative ML framework as illustrated in FIG. 5 represents an example embodiment configuration.

Additionally, although the invention has been described with reference to several embodiments and an example embodiment configuration, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for a generative machine learning (ML) framework generating predictive results regarding financial transactions, the method being implemented by at least one processor, the method comprising:
generating the generative ML framework by connecting a plurality of layers, wherein the plurality of layers comprises: a base layer positioned as a bottom layer of the generative ML framework; a data processing layer; at least one large language model (LLM) layer; a ML processing layer; and an applications layer positioned as a top layer in the generative ML framework; and
executing the generative ML framework by performing operations comprising:
storing, at the base layer, a first data from a plurality of databases;
receiving, by the data processing layer, the first data at the base layer;
performing, by the data processing layer, data processing procedures on the first data that results in a standardized data for input into the at least one LLM layer, wherein the standardized data comprises an association with at least one specific case that comprises the financial transactions;
parsing, by the at least one LLM layer, the standardized data to generate analytical results with natural language descriptions of the analytical results;
inputting, by the at least one LLM layer into the ML processing layer, the analytical results;
performing, by the ML processing layer, predictive modeling of the analytical results to generate the predictive results;
transmitting, by the ML processing layer to the applications layer, the predictive results; and
generating, by the applications layer, at least one application model based on the predictive results.

2. The method of claim 1, wherein the generating the generative ML framework by connecting the plurality of layers comprises:
connecting the base layer positioned as the bottom layer of the generative ML framework with the data processing layer;
connecting the data processing layer with the at least one large LLM layer;
connecting the at least one LLM layer with the ML processing layer; and
connecting the ML processing layer with the applications layer positioned as the top layer in the generative ML framework.

3. The method of claim 1, wherein the received first data comprises at least one from among business data, commercial data, financial records data, transaction logs data, and current test case data; and
wherein the plurality of databases comprises at least one from among historical databases, business databases, financial databases, and software testing databases.

4. The method of claim 1, wherein the performing the data processing procedures comprises:
extracting the first data from the plurality of databases at the base layer;
transforming the first data into a predetermined standardized format resulting in the standardized data; and
loading the standardized data for the input into the at least one LLM layer.

5. The method of claim 4, wherein the transforming the first data into the predetermined standardized format comprises at least one from among:
normalization of the first data;
converting unstructured data into structured data;
validating the first data;
cleansing the first data to remove at least one from among errors, duplications, and corruptions of the first data; and
tokenization of the first data.

6. The method of claim 1, wherein the performing the predictive modeling comprises performing at least one from among classification, clustering, regression, and anomaly detection of the analytical results; and
wherein the method further comprises performing, by the ML processing layer, a generation of at least one synthetic test case data associated with the at least one specific case based on the predictive modeling.

7. The method of claim 1, wherein the generating of the at least one application model comprises:
implementing automated user acceptance testing (UAT) processes for at least one test case data associated with the at least one specific case;
creating a fully integrated user testing framework with a corresponding application programming interface associated with the implemented UAT processes; and
constructing a feedback loop incorporated with the fully integrated user testing framework to obtain user feedback for updating the generative ML framework via the applications layer.

8. The method of claim 1, wherein the parsing of the standardized data comprises:
performing natural language processing (NLP) comprising sentiment analysis, entity recognition, and summarization of the standardized data; and
performing risk assessment associated with the standardized data.

9. The method of claim 1, wherein the method further comprises performing, by the at least one LLM layer, of at least one from among:
transfer learning between different LLM models;
fine tuning of hyperparameters;
multi-task learning;
multi-modal learning; and
model interpretations and explanations via at least one from among attention mechanisms, saliency maps, and feature analyses.

10. A computing apparatus for implementing a generative machine learning (ML) framework generating predictive results regarding financial transactions, comprising:
a processor;
a memory;
a display; and
a communication interface coupled to each of the processor, the memory, and the display, wherein the processor is configured to:
generate the generative ML framework by connecting a plurality of layers, wherein the plurality of layers comprises: a base layer positioned as a bottom layer of the generative ML framework; a data processing layer; at least one large language model (LLM) layer; a ML processing layer; and an applications layer positioned as a top layer in the generative ML framework; and
execute the generative ML framework by performing operations comprising:
store, at the base layer, a first data from a plurality of databases;
receive, by the data processing layer, the first data at the base layer;
perform, by the data processing layer, data processing procedures on the first data that results in a standardized data for input into the at least one LLM layer, wherein the standardized data comprises an association with at least one specific case that comprises the financial transactions;
parse, by the at least one LLM layer, the standardized data to generate analytical results with natural language descriptions of the analytical results;
input, by the at least one LLM layer into the ML processing layer, the analytical results;
perform, by the ML processing layer, predictive modeling of the analytical results to generate the predictive results;
transmit, by the ML processing layer to the applications layer, the predictive results; and
generate, by the applications layer, at least one application models based on the predictive results.

11. The computing apparatus of claim 10, wherein the generate the generative ML framework by connecting the plurality of layers comprises:
connecting the base layer positioned as the bottom layer of the generative ML framework with the data processing layer;
connecting the data processing layer with the at least one large LLM layer;
connecting the at least one LLM layer with the ML processing layer; and
connecting the ML processing layer with the applications layer positioned as the top layer in the generative ML framework.

12. The computing apparatus of claim 10, wherein the perform the data processing procedures comprises:
extracting the first data from the plurality of databases at the base layer;
transforming the first data into a predetermined standardized format resulting in the standardized data; and
loading the standardized data for the input into the at least one LLM layer.

13. The computing apparatus of claim 12, wherein the transforming the first data into the predetermined standardized format comprises at least one from among:
normalization of the first data;
converting unstructured data into structured data;
validating the first data;
cleansing the first data to remove at least one from among errors, duplications, and corruptions of the first data; and
tokenization of the first data.

14. The computing apparatus of claim 10, wherein the perform the predictive modeling comprises performing at least one from among classification, clustering, regression, and anomaly detection of the analytical results; and
wherein the processor is further configured to perform, by the ML processing layer, a generation of at least one synthetic test case data associated with the at least one specific case based on the predictive modeling.

15. The computing apparatus of claim 10, wherein the parse of the standardized data comprises:
performing natural language processing (NLP) comprising sentiment analysis, entity recognition, and summarization of the standardized data; and
performing risk assessment associated with the standardized data; and
wherein the processor is further configured to perform, by the at least one LLM layer, procedures comprising at least one from among:
transfer learning between different LLM models;
fine tuning of hyperparameters;
multi-task learning;
multi-modal learning; and
model interpretations and explanations via at least one from among attention mechanisms, saliency maps, and feature analyses.

16. A non-transitory computer readable storage medium storing instructions for a generative machine learning (ML) framework generating predictive results regarding financial transactions, the non-transitory computer readable storage medium comprising executable code which, when executed by a processor, causes the processor to:
generate the generative ML framework by connecting a plurality of layers, wherein the plurality of layers comprises: a base layer positioned as a bottom layer of the generative ML framework; a data processing layer; at least one large language model (LLM) layer; a ML processing layer; and an applications layer positioned as a top layer in the generative ML framework; and
execute the generative ML framework by performing operations comprising:
store, at the base layer, a first data from a plurality of databases;
receive, by the data processing layer, the first data at the base layer;
perform, by the data processing layer, data processing procedures on the first data that results in a standardized data for input into the at least one LLM layer, wherein the standardized data comprises an association with at least one specific case that comprises the financial transactions;
parse, by the at least one LLM layer, the standardized data to generate analytical results with natural language descriptions of the analytical results;
input, by the at least one LLM layer into the ML processing layer, the analytical results;
perform, by the ML processing layer, predictive modeling of the analytical results to generate the predictive results;
transmit, by the ML processing layer to the applications layer, the predictive results; and
generate, by the applications layer, at least one application models based on the predictive results.

17. The non-transitory computer readable storage medium of claim 16, wherein the generate the generative ML framework by connecting the plurality of layers comprises:
connecting the base layer positioned as the bottom layer of the generative ML framework with the data processing layer;
connecting the data processing layer with the at least one large LLM layer;
connecting the at least one LLM layer with the ML processing layer; and
connecting the ML processing layer with the applications layer positioned as the top layer in the generative ML framework.

18. The non-transitory computer readable storage medium of claim 16, wherein the perform the data processing procedures comprises:
extracting the first data from the plurality of databases at the base layer;
transforming the first data into a predetermined standardized format resulting in the standardized data; and
loading the standardized data for the input into the at least one LLM layer; and
wherein the transforming the first data into the predetermined standardized format comprises at least one from among:
normalization of the first data;
converting unstructured data into structured data;
validating the first data;
cleansing the first data to remove at least one from among errors, duplications, and corruptions of the first data; and
tokenization of the first data.

19. The non-transitory computer readable storage medium of claim 16, wherein the performs the predictive modeling comprises performing at least one from among classification, clustering, regression, and anomaly detection of the analytical results; and
wherein the non-transitory computer readable storage medium comprises further executable code which causes the processor to perform, by the ML processing layer, a generation of at least one synthetic test case data associated with the at least one specific case based on the predictive modeling.

20. The non-transitory computer readable storage medium of claim 16, wherein the parsing of the standardized data comprises:
performing natural language processing (NLP) comprising sentiment analysis, entity recognition, and summarization of the standardized data; and
performing risk assessment associated with the standardized data; and
wherein the non-transitory computer readable storage medium comprises further executable code which causes the processor to further perform, by the at least one LLM layer, procedures comprising at least one from among:
transfer learning between different LLM models;
fine tuning of hyperparameters;
multi-task learning;
multi-modal learning; and
model interpretations and explanations via at least one from among attention mechanisms, saliency maps, and feature analyses.
